(19) United States
(12) Patent Application Publication
(10) Pub. No.: US 2023/0036635 A1
(43) Pub. Date: Feb. 2, 2023

(54) SYSTEMS AND METHODS FOR CAPTURING CARBON DIOXIDE

(71) Applicant: NOYA, INC., San Francisco, CA (US)

(72) Inventors: Joshua Ivan Santos-Heard, San Francisco, CA (US); Daniel Cavero Rodriguez, San Francisco, CA (US); Laurene Petitjean, San Francisco, CA (US); Alexandra Justine Wetch, Los Angeles, CA (US)

(21) Appl. No.: 17/816,304

(22) Filed: Jul. 29, 2022

Related U.S. Application Data
(60) Provisional application No. 63/227,743, filed on Jul. 30, 2021.

(51) Int. Cl. B01D 53/14; B01D 53/62; B01J 20/08; B01J 20/04; B01J 20/20

(52) U.S. Cl. CPC B01D 53/1475; B01D 53/62; B01J 20/08; B01J 20/043; B01J 20/20; B01D 2257/504; B01D 2252/10; B01D 2258/0283

(57) ABSTRACT

A system, apparatus and methods are described for extracting carbon dioxide from air. The system may receive air blown over a contactor. The contactor can be coupled to a cooling tower. The contactor may comprise sorbent material to absorb carbon dioxide from the blown air. The sorbent material may be transported and placed into a regeneration reactor. The carbon dioxide in the sorbent material may be extracted via the regeneration reactor. The extracted carbon dioxide may be pressurized into and stored in a pressurized container.

### CROSS-REFERENCE TO RELATED APPLICATIONS

This application claims benefit of U.S. Provisional Patent Application No. 63,227,743, filed Jul. 30, 2021, which is incorporated herein in its entirety by reference thereto.

### FIELD

The present disclosure relates generally to systems and methods for carbon dioxide capture. More particularly, the described embodiments relate to systems and methods for carbon dioxide capture from the air flow from cooling towers using a carbon dioxide absorbing solid sorbent material.

### BACKGROUND

The dangerously high levels of atmospheric carbon dioxide present a need for inexpensive, scalable processes to draw down atmospheric concentrations and ensure we have a long and safe existence on the planet. Accordingly, it would be desirable to provide a system and method to extract carbon dioxide from the air.

### BRIEF SUMMARY

Some embodiments are directed to a system, apparatus, and methods of extracting carbon dioxide from the air. In one embodiment, the system may receive air blown over a contactor. The contactor may comprise sorbent material to absorb carbon dioxide from the blown air. The sorbent material may be transported and placed into a regeneration reactor. The carbon dioxide in the sorbent material may be extracted via the regeneration reactor. The extracted carbon dioxide may be pressurized into a pressurized container. After extracting the carbon dioxide, transporting the sorbent material from the regeneration reactor to the air contactor. The sorbent material may include compositions including MgO, Al₂O₃ and/or K₂CO₃, activated carbon, monoethylamine, glycine, or sarcosine.

In some embodiments, the carbon dioxide in the flue gas from, for example, natural gas boilers in commercial real estate buildings can be routed through the air contactor for additional carbon dioxide capture.

In some embodiments, the air contactor can sit at various places on a cooling tower, for example directly on top of the cooling tower to eliminate the need for ducting or at the inlet airflow into the cooling tower.

In some embodiments, a fan will be used to add a small amount of additional energy to the moving stream of air.

In some embodiments, regeneration of the solid sorbent is performed in the air contactor.

In some embodiments, structures may be used to reduce particulate emissions (drift) from a cooling tower.

### BRIEF DESCRIPTION OF THE FIGURES

FIG. 1 illustrates a cooling tower according to some embodiments.

FIG. 2 illustrates a sorbent transport system according to some embodiments.

FIGS. 3A-3D illustrate absorber structures according to some embodiments.

FIG. 4 illustrates an air permeable conveyor according to some embodiments.

FIG. 5 illustrates an air permeable conveyor according to some embodiments.

FIGS. 6A-6B illustrate a semi-continuous sorbent transport system according to some embodiments.

FIG. 7 illustrates an air redirection configuration according to some embodiments.

FIGS. 8A-8K illustrate configurations of systems according to some embodiments.

FIG. 9 illustrates a configuration for conveying solid sorbent into an air contactor according to some embodiments.

### DETAILED DESCRIPTION

A significant portion of greenhouse gas emissions comes from carbon dioxide. Carbon dioxide in the atmosphere can increase from industrial processes, land changes (e.g., deforestation), and burning fossil fuels, which can contribute to issues related to climate change. Reducing carbon dioxide in the atmosphere has become a priority across many governments and industries. One way to reduce carbon dioxide emissions is to avoid emissions altogether, but avoiding emissions often requires significant modifications and/or capital improvements to modify existing systems and processes.

Another way to reduce carbon dioxide emissions is to prevent the emissions from remaining in the atmosphere, for example by capturing and sequestering carbon dioxide from emissions or from the air. However, existing systems for capturing and sequestering carbon dioxide often use significant amounts of raw materials, fresh water, and energy. Accordingly, there is a need for a system that can remove carbon dioxide from air, industrial emissions, building cooling towers, etc. while reducing or eliminating the use of raw materials, fresh water, etc.

Embodiments disclosed herein overcome these and other challenges by providing— among other benefits—systems and methods for removing carbon dioxide from the atmosphere. In some embodiments, the system includes a combination of industrial cooling towers and a solid carbon dioxide capture sorbent. Cooling towers can be used, for example, on buildings and in industrial processes to remove heat from the building or process to the atmosphere or to provide cooling to an industrial process. In some embodiments, cooling towers can be used to provide the energy needed to move air that contains carbon dioxide into a sorbent that can capture that carbon dioxide.

In some embodiments, an air contactor (e.g., contactor 1200) may be coupled to a cooling tower (e.g., cooling tower 1100). In some embodiments, the air contactor may be disposed on top of a cooling tower where effluent air flows of the cooling tower. In some embodiments, the air contactor may be coupled to a top of the cooling tower where effluent air flows out of the cooling tower. In some embodiments, the air contactor may be fixedly coupled to the cooling tower (e.g., bolted or attached onto the top of a cooling tower). In some embodiments, air contactor (e.g., contactor 1200) may be coupled to cooling tower (e.g., cooling tower 1100) at an inlet of the cooling tower. In some embodiments, the air contactor is removably coupled to the cooling tower. In some embodiments, the arrangement of the air contactor on the cooling tower as described herein can eliminate the need for ducting to direct the air to the air contactor.

In some embodiments, the air contactor may redirect the air into a series of ducts that leads the air to the air contactor. In some embodiments, the air contactor includes at least one sorbent. In some embodiments, the sorbent is a solid sorbent. In some embodiments, the sorbent includes a solid carbon dioxide capture sorbent. In some embodiments, the sorbent absorbs a stream of carbon dioxide from a mixture of other gases (e.g., from air). In some embodiments, gasses other than air (e.g., flue gas from boilers and other processes) may also be routed through the air contactor for capturing additional carbon dioxide. In some embodiments, the carbon dioxide in the flue gas of commercial real estate buildings can be routed through the air contactor for additional carbon dioxide capture.

In some embodiments, the sorbent collects carbon dioxide from gas flowing through the air contactor until the sorbent is saturated. Upon reaching saturation, in some embodiments, the solid sorbent may be moved into a regenerator reactor (e.g., regeneration reactor 1500). In some embodiments, the regenerator reactor may be used to release carbon dioxide from the sorbent. This may be done, for example, by adding heat to the sorbent, which can cause the captured carbon dioxide released. In some embodiments, the regenerator reactor is integrated into the air contactor as one single component. In some embodiments, the regenerator is a separate from the air contactor. In some embodiments, the released carbon dioxide is pressurized and transported to an end-use location. In some embodiments, the released carbon dioxide is pressured to a pressure between about 400 psi to about 800 psi. In some embodiments, the released carbon dioxide is liquefied. In some embodiments, after the carbon dioxide is released, the solid sorbent can be reused to capture additional carbon dioxide from air from the cooling tower.

Systems and methods disclosed herein allow for the use of cooling towers in conjunction with a solid sorbent to both provide cooling to industrial processes and to act as a direct air carbon capture device. This allows for the use of existing infrastructure (such as industrial cooling towers) and existing operational spend to capture carbon dioxide from ambient air at an inherently lower cost and in a scalable way. Additionally, the use of a solid sorbent minimizes emissions to the environment (drift, evaporation) and lowers costs of sorbent replenishment.

Another benefit is that the solid sorbent requires lower thermal energy input to regenerate and liberate carbon dioxide and allows for lower process operational costs. Additionally, flue gasses may be captured from buildings and other processes with the systems and methods described herein. Thus, allowing the system to simultaneously remove carbon dioxide from the air and prevent new carbon dioxide from getting into the atmosphere.

Sorbent Compositions

Various solid sorbent compositions may be used to absorb carbon dioxide. In some embodiments, the sorbent is a carbon dioxide sorbent. In some embodiments, the sorbent comprises at least one of magnesium oxide (“MgO”), aluminum oxide (“Al₂O₃”), potassium carbonate (“K₂CO₃”), activated carbon, monoethylamine, glycine, or sarcosine, or a combination thereof. In some embodiments, the sorbent composition is an MgO Aerogel. In some embodiments, the solid sorbent composition is Al₂O₃. These materials have several benefits, including that it is a structural element, is sinterable, stable, resistant to moisture, easy to control, porous, inexpensive, and formable. in some embodiments, the solid sorbent composition is K₂CO₃. In some embodiments, the sorbent composition is a wash-coated Al₂O₃/K₂CO₃ on cordierite. The foregoing compositions may be combined together in different weights and quantities. Other compositions of solid sorbent may be suitable for use with the systems and methods as disclosed herein, such as activated carbon, monethylamine, glycine, or sarcosine. The solid sorbent may have different capture rates. As used herein, the capture rate is the amount of gas in millimoles absorbed by the sorbent per minute per gram of sorbent. In some embodiments, the sorbent has a carbon dioxide capture rate of about 0.01 to about 2 mmol/min/g of sorbent (e.g., about 0.02 to about 1.5 mmol/min/g of sorbent, about 0.5 to about 1 mmol/min/g of sorbent). In some embodiments, the sorbent material has a carbon dioxide capture rate of about 0.024 to about 0.034 mol/min/g of the sorbent material. In some embodiments, the sorbent material has a carbon dioxide capture rate of about 0.1 to about 1.12 mmol/min/g of sorbent material.

In some embodiments, the air contactor includes at least 35 kg of sorbent. In some embodiments, the sorbent has a capacity of about 0.1 mmol/g to about 1.2 mmol/g of gas (e.g., carbon dioxide).

Sorbent Replacement

As described herein, the solid sorbent may absorb carbon dioxide from air. In some embodiments, sorbent particles may be used to absorb carbon dioxide. Over time, the sorbent particle would be subjected to wear and abrasive forces as the sorbent particles are transported from the air contactor to the regeneration reactor. In some embodiments, the sorbent particles are replaced when the particle size is smaller (due to attrition) than the absorption container's “permeable” holes. In some embodiments, when the solid sorbent is formed as pellets or monoliths, the sorbent can be reground and recompacted or sintered to the desired shape and size.

Sensors and Monitors

In some embodiments, carbon dioxide sensors may also be used at various places throughout the system, for example at an inlet and/or outlet of a cooling tower. The carbon dioxide sensors may help to understand the absorption rate and allow the system to determine an amount of carbon dioxide likely captured by the sorbent. In some embodiments, based on the determination, the sorbent may be transported from the air contactor to the regeneration reactor. In some embodiments, the system may provide reporting or other information to a user via a user interface of a computer system. For example, a computer system may provide a notification, alert, or report that the sorbent is ready to be moved to the regeneration reactor. Both the contactor and regeneration reactors may include various other sensors, for example temperature and humidity sensors. In some embodiments, the regeneration reactor is temperature controlled and the thermal power (electric, combustion, electromagnetic) can be controlled by the thermal sensors.

Regeneration Reactor

A regeneration reactor (also referred to as a regen reactor) may be used to process the solid sorbent after the sorbent has captured carbon dioxide.

In some embodiments, the regeneration reactor regenerates (i.e., releases) the captured carbon dioxide by heating up the carbon dioxide saturated solid sorbent from the contactor to temperatures high enough to cause the sorbent to release the carbon dioxide. In some embodiments, the regeneration reactor heats the saturated sorbent to a temperature of about 80° C. to about 600° C. (e.g., about 80° C. to about 200° C., about 80° C. to about 150° C., about 100° C. to about 150° C., or about 150° C. to about 600° C. In some embodiments, the regeneration reactor heats the saturated sorbent under a vacuum. In some embodiments, the sorbent is maintained at an elevated temperature for about 15 minutes to about 200 minutes (e.g., about 15 minutes to about 60 minutes, about 30 minutes to about 200 minutes, or about 150 minutes to about 200 minutes) before the regeneration cycle is complete.

Carbon Dioxide Extraction System

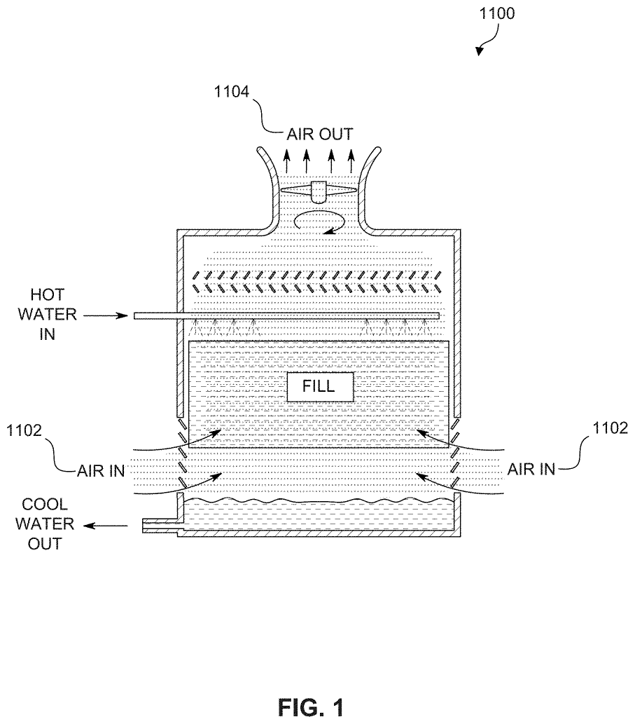

FIG. 1 illustrates an example of a cooling tower 1100 that may be used with carbon dioxide extractions systems according to some embodiments disclosed herein. In some embodiments, air can enter cooling tower 1100 through air inlet 1102. In some embodiments, air can exit cooling tower 1100 through air outlet 1104. As illustrated in FIG. 1, air is shown being received by industrial cooling tower 1100 (e.g., at air inlet 1102) and blown out of the top of cooling tower 1100 (e.g., at air outlet 1104).

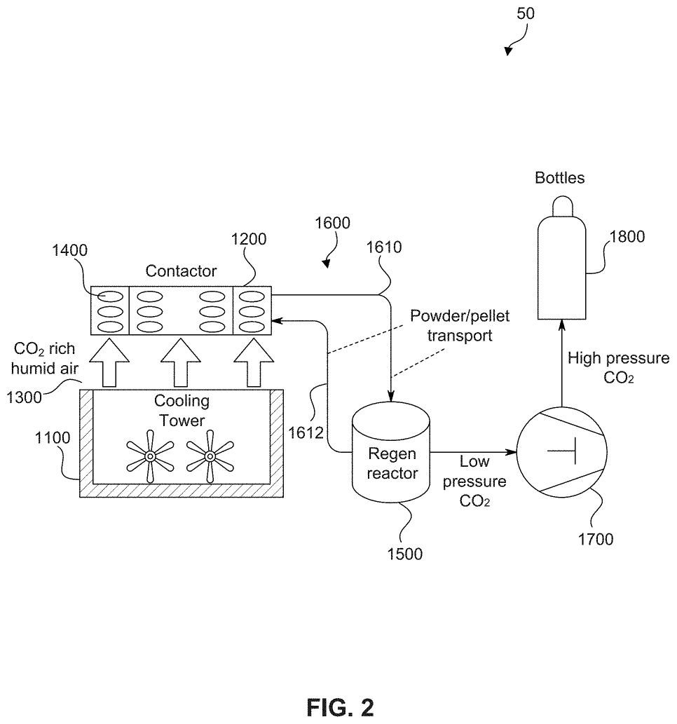

FIG. 2 illustrates system 50 according to some embodiments. System 50 may include cooling tower 1100, contactor 1200, sorbent 1400, transport system 1600, regeneration reactor 1500, gas capturing system 1700, and storage system 1800. In some embodiments, system 50 includes transport system 1600 that is configured to transport the sorbent material in a continuous manner between contactor 1200 and regeneration reactor 1500. In some embodiments, transport system 1600 includes a conveyor with first portion 1610 that transports saturated sorbent from contactor 1200 to regeneration reactor 1500. In some embodiments, transport system 1600 includes a conveyor with a second portion 1612 that transports sorbent from regeneration reactor 1500 back to contactor 1200. As illustrated in FIG. 2, contactor 1200 can be disposed in a location such that carbon dioxide rich humid air 1300 exiting cooling tower 1100 (e.g., being blown out of cooling tower 1100) is passed into air contactor 1200. In some embodiments, carbon dioxide rich humid air 1300 has a carbon dioxide concentration of about 300 ppm to about 420 ppm. In some embodiments, air contactor 1200 may be designed with permeable walls or structures allowing air flow from cooling tower 1100 to pass through and over solid sorbent 1400. For example, in some embodiments, air contactor 1200 may be constructed as a bin with orifices or holes disposed about the walls of the bin. In some embodiments, air contactor 1200 may include a frame where solid sorbent 1400 is attached to the frame in various shapes and porosities. In some embodiments, the sorbent is a “monolith” shape and porous with an internal surface area of about 300 m³/g to about 1000 m³/g.

FIG. 2 illustrates a continuous process of carbon dioxide capture via sorbent 1400 where sorbent 1400 captures carbon dioxide via an air contactor 1200. In some embodiments, sorbent 1400 is a transportable sorbent. In some embodiments, sorbent 1400 is transported after adsorbing carbon dioxide. In some embodiments, sorbent 1400 with the carbon dioxide is transported to a regeneration reactor 1500. In some embodiments, captured carbon dioxide is released from sorbent 1400 at regeneration reactor 1500. In some embodiments, sorbent 1400 is transported back to air contactor 1200 after carbon dioxide is released from sorbent 1400. In some embodiments, air contactor 1200 may be configured with a transport system 1600 that moves physical solid sorbent 1400 (such as small pellets, powders, monoliths, disk, fibers, short fibers) from air contactor 1200 to regeneration reactor 1500. In some embodiments, transport system 1600 moves sorbent 1400 from air contactor to regeneration reactor 1500 via conveyor 1610. In some embodiments, sorbent 1400 is then processed by regeneration reactor 1500 to extract carbon dioxide from sorbent 1400. In some embodiments, after carbon dioxide is extracted from sorbent 1400, sorbent 1400 may be used again to capture more carbon dioxide. In some embodiments, transport system 1600 moves sorbent 1400 from the regeneration reactor 1500 to the air contactor 1200 via conveyor 1620. In some embodiments, the regeneration reactor 1500 may have a chamber where sorbent 1400 can be placed. In some embodiments, regeneration reactor 1500 may include a chamber for creating and sustaining a vacuum environment where air and other gasses may be vacuumed. In some embodiments, after creating a vacuum environment, sorbent 1400 may be heated to release carbon dioxide. In some embodiments, the released carbon dioxide may then be captured in a gas capturing system 1700. In some embodiments, gas capturing system 1700, may be pressurize and/or bottle the carbon dioxide. In some embodiments, gas capturing system 1700 includes a compressor for pressurizing the carbon dioxide. In some embodiments, gas capturing system 1700 pressurizes the carbon dioxide to a pressure of about 800 psi or to a pressure and temperature of liquefaction.

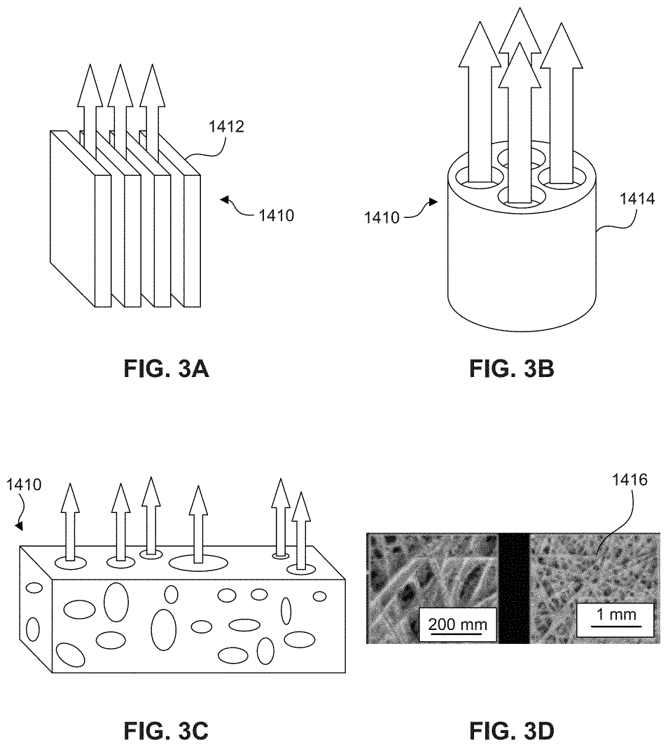

FIGS. 3A-3D illustrate example embodiments of various sorbent structures 1410. The air contactor (e.g., contactor 1200) may be configured with different sorbent structures 1410. In some embodiments, sorbent structures 1410 may be transported continuously or semi-continuously between contactor 1200 and regeneration reactor 1500. Some of these sorbent structures may be transported via continuous system from and to air contactor 1200 and/or transported via a semi-continuous system. In some embodiments, as shown in FIG. 3A, the system may have structures with fins 1412. In some embodiments, fins 1412 may be solid, coated, and/or porous. In some embodiments, as shown in FIG. 3B, the system may use structures 1414 of the sorbent that are monoliths/pellets. In some embodiments, structures 1414 may be porous, with channels, and/or solid. In some embodiments, sorbent structure 1410 may be a monolith 1414, as shown in FIG. 3B. In some embodiments, as shown in FIG. 3C, structure 1410 may include a porous structure. In some embodiments, the system may use structures with a membrane 1416 that may be fibrous, porous, coated and/or disks, as shown in FIG. 3D.

Different types of absorbent macro-geometries of the sorbent may include beads, powder, granules, pellets, monoliths, foam, laminate, fabric structures, and/or a combination thereof. As described herein, these macro-geometries of the sorbent may be transported from an air contactor to the regeneration reactor via a continuous or semi-continuous process. Comparing to beads, pellet, or power sorbent, structured sorbent, such as monoliths, foam, laminate, or fabric structures, may provide faster mass transfer kinetics and thus shorter diffusion path, easier heat transfer in all directions, and more uniform temperature distribution. However, the loading of structured sorbent on mass/volume basis is lower. The volume of sorbent 1400 used in system 50 can be directly related to cycle time of system 50. In some embodiments, as used herein, “cycle time” refers to the time it takes for sorbent 1400 to move from air contactor 1200 to regeneration reactor 1500 and back to air contactor 1200. For example, in some embodiments, as cycle time decreases so does volume of sorbent 1400, and as cycle time increases so does volume of sorbent 1400.

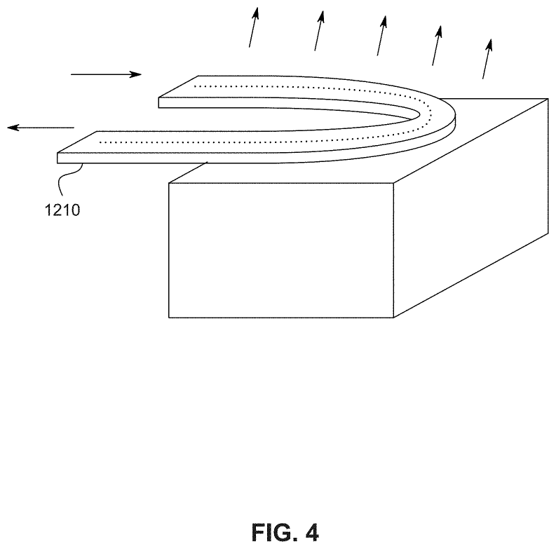

FIG. 4 illustrates an air permeable conveyor 1210 according to some embodiments. For example, in some embodiments, conveyor 1210 may be constructed with tubes and actuated by blowers or be constructed like a baggage conveyor to transport small pellets, powders, monoliths, disk, fibers, or short fibers. In some embodiments, air permeable conveyor 1210 has perforations or openings disposed about conveyor 1210 with solid sorbent 1400 transported via air permeable conveyor 1210. In some embodiments, air collector 1200 and/or conveyor 1210 may have internal air turbulators or structures to increase air turbulence.

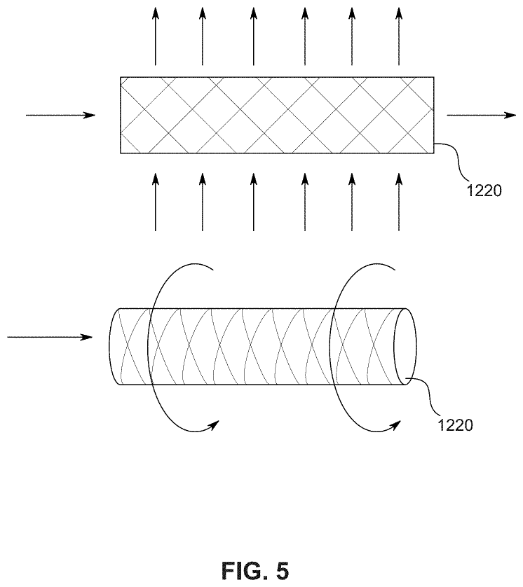

FIG. 5 illustrates an example an air permeable conveyor 1220 according to some embodiments. For example, in some embodiments, conveyor 1220 may be constructed with tubes and actuated by blowers or be constructed like a baggage conveyor to transport small pellets, powders, monoliths, disk, fibers, or short fibers. For example, similar to air permeable conveyor 1210 of FIG. 4, in some embodiments, the conveyor has perforations and/or openings to receive air flow over sorbent 1400. In some embodiments, conveyor 1220 may be spun or rotated. In some embodiments, a blower and/or fan may be used to increase air flow through conveyor 1220.

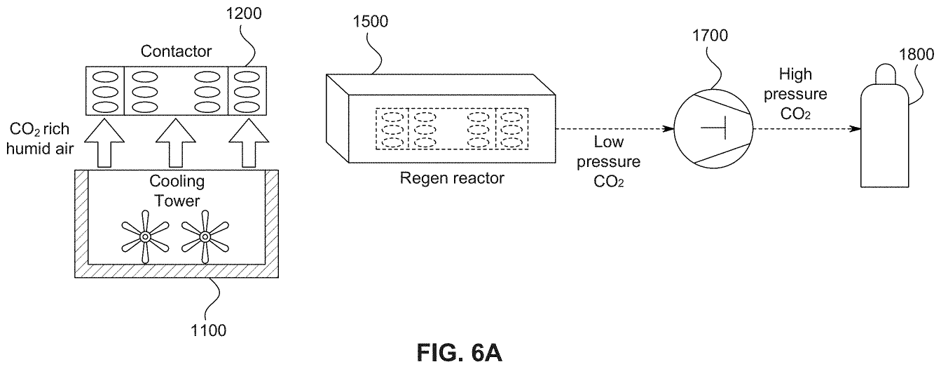

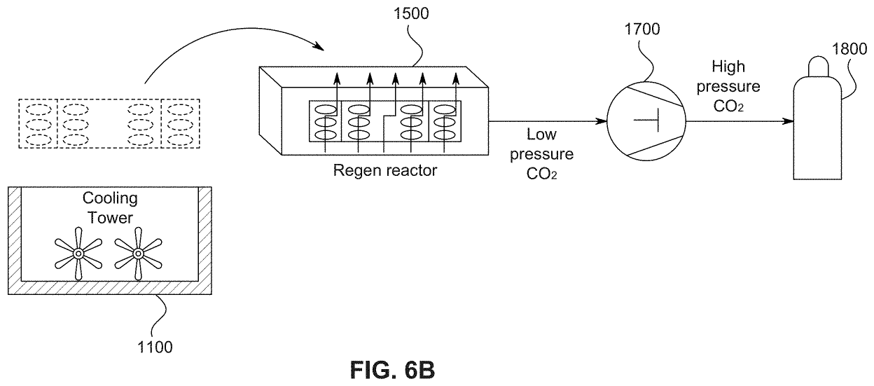

FIGS. 6A-6B illustrate a semi-continuous process according to some embodiments. FIG. 6A illustrates a configuration where air contactor 1200 is transportable. In some embodiments, contactor 1200 may have carbon dioxide sorbent 1400 built into (e.g., integral with) or placed within the structure of air contactor 1200. For example, in some embodiments, air contactor 1200 may have receiving bins that receive cartridges that include fibrous sorbent material (e.g., sorbent 1400). In some embodiments, the cartridges are removable and may be removed from air contactor 1200 after capturing carbon dioxide. In some embodiments, the cartridge is placed into regeneration reactor 1500. In some embodiments, air contactor 1200 itself may be moved from its position over air-cooling tower 1100, and the entire air contactor 1200 may be placed into regeneration reactor 1500, as shown in FIG. 6B. Similarly, as discussed in the continuous process, regeneration reactor 1500 may be utilized to cause sorbent 1400 to release the captured carbon dioxide where it may then be stored in a pressurized storage system (e.g., storage system 1800). After air contactor 1200 has been processed (e.g., after carbon dioxide has been released), it then may be moved back to a position over air-cooling tower 1100 to capture carbon dioxide from air blown through and/or received by air contactor 1200.

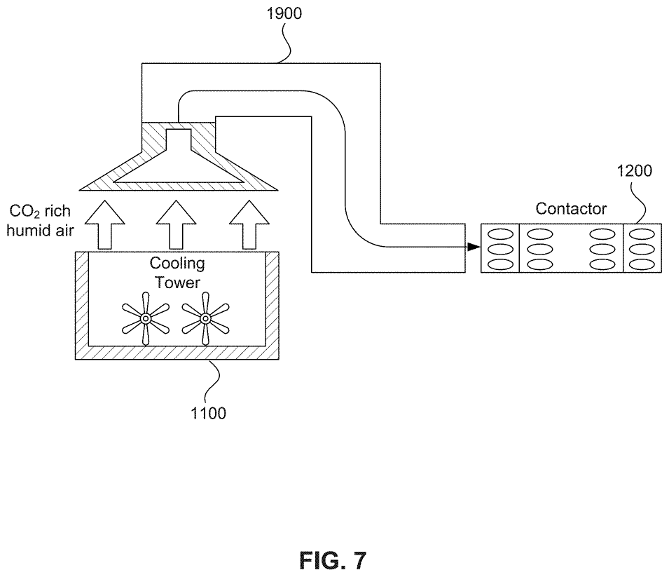

FIG. 7 illustrates an air redirection configuration according to some embodiments. FIG. 7 illustrates a mechanism or apparatus 1900 to redirect air flow from the cooling tower. For example, tubing or other conduits (e.g., ducts) may be used to redirect air blown from air-cooling tower 1100 to air contactor 1200. In some embodiments, air contactor 1200 may be placed or located at a position and a distance located away from air-cooling tower 1100. In some embodiments, air contactor 1200 may be disposed at a location remote from cooling tower 1100.

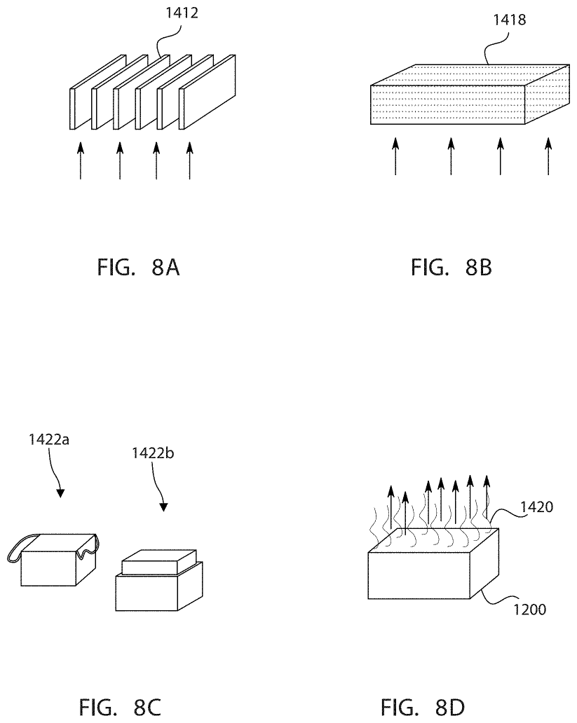

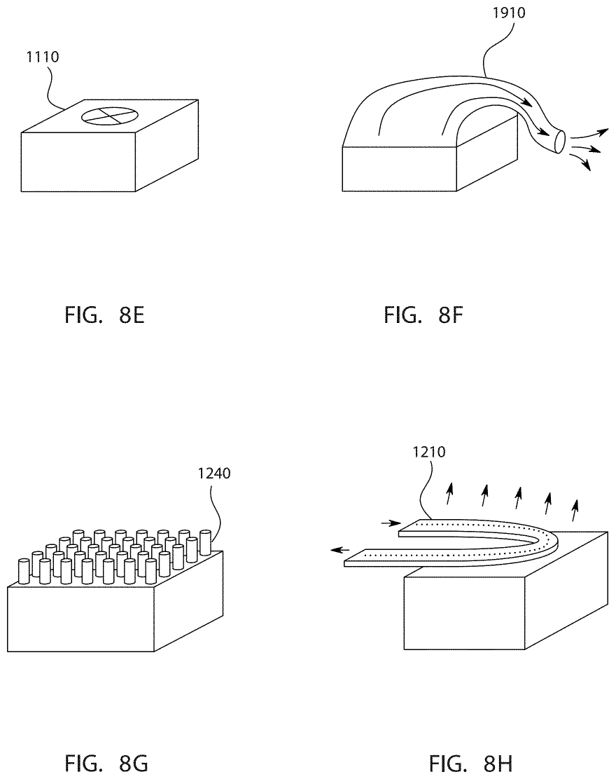

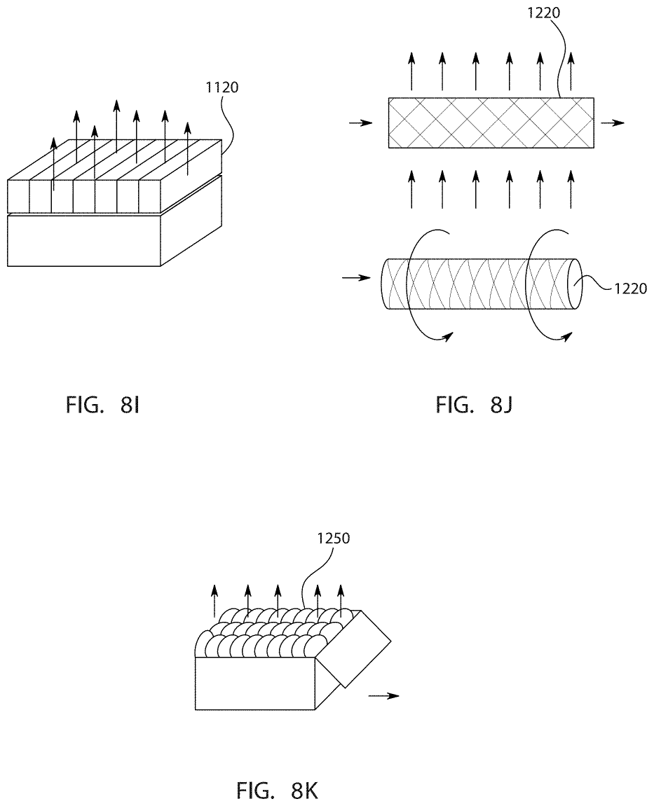

FIGS. 8A-8K illustrate configurations of systems according to some embodiments. In some embodiments, sorbent 1400 may be a fluidized bed. FIG. 8A shows an example of fins 1412. In some embodiments, fins 1412 include a sorbent material (e.g., sorbent 1400). In some embodiments, sorbent 1400 is applied to the fins (e.g., as a coating). In some embodiments, fins 1412 are impregnated with sorbent 1400. In some embodiments, fins 1412 are made of a foam-like material 1418, illustrated in FIG. 8B. FIG. 8C shows an example of an inflatable structure. For example, structure 1422a shown in FIG. 8C shows the inflatable structure in a deflated state and structure 1422b shown in FIG. 8C shows the inflatable structure in an inflated state. In some embodiments, sorbent 1400 (for example loose particulate, powder or fiber) may be placed in the inflatable structure. FIG. 8D illustrates fibers 1420 extending from contactor 1200. In some embodiments, fibers 1420 are flexible. In some embodiments, fibers 1420 are swaying fibers made of, or having applied, the solid sorbent is shown. In some embodiments, fibers 1420 are made of the sorbent material. In some embodiments, fibers 1420 have the sorbent materials (e.g., sorbent 1400) applied on a surface of fibers 1420. In some embodiments, fibers 1420 are made of sorbent 1400. Fibers 1420 for example may be attached to air contactor 1200. FIG. 8E shows a fan or blower 1110 that may be used to aid in the movement of the air from cooling tower 1100 to and through the sorbent 1400. FIG. 8F shows an embodiment with a duct 1910 to move air to another location. FIG. 8G shows an array of tubes 1240. In some embodiments, tubes 1240 may be infused with (e.g., impregnated with) sorbent 1400. In some embodiments, tubes 1240 may have sorbent 1400 applied to tubes 1240. FIG. 8H shows an example of a configuration with a conveyor 1210 to, for example, move solid sorbent 1400 from an area that receives air to a regeneration reactor 1500. FIG. 8I illustrates a configuration to aid in directing air and assisting in drift elimination. For example, in some embodiments, a drift eliminator 1120 may be placed at air outlet 1104 of cooling tower 1100 and the contactor 1200 to reduce the humidity of the air blown over the solid sorbent 1400. Drift eliminator 1120 may act as a condenser providing a slight temperature decrease and may cause some of the vapor to condense and may cause droplets of water in the air to adhere to the surfaces of drift eliminator 1120. FIG. 8J illustrates embodiments of radial air conveyor 1220 with openings (e.g., perforations) to receive air flow to solid sorbent 1400 disposed in air conveyor 1220. FIG. 8K shows an example of the permeable hoppers 1250 that may be used to contain the solid sorbent 1400, and hoppers 1250 may be transported to regeneration reactor 1500.

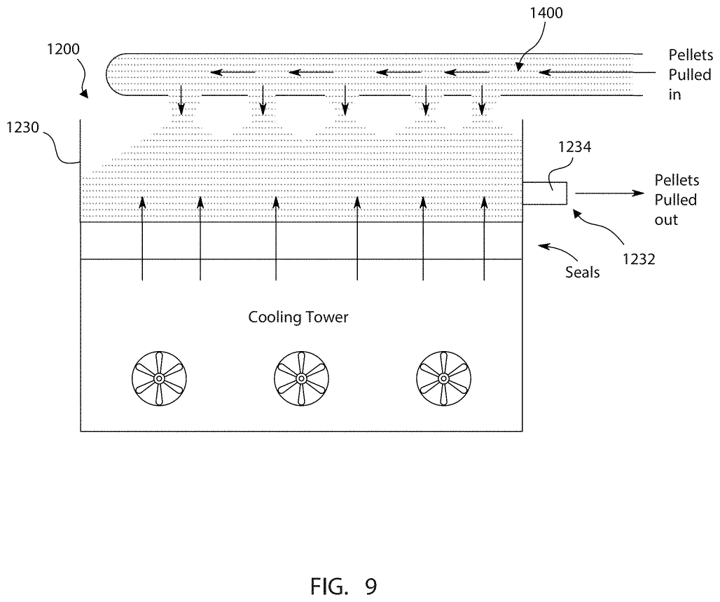

In some embodiments, sorbent 1400 comprises solid sorbent pellets. FIG. 9 illustrates an example of a configuration for conveying solid sorbent pellets into air contactor 1200. In some embodiments, solid sorbent pellets are pushed into or released into a chamber 1230, and solid sorbent pellets are pulled out of the bottom of chamber 1230. In some embodiments, chamber 1230 is disposed within a container. For example, in some embodiments, the bottom of chamber 1230 may have conveyor 1234 for moving sorbent 1400. In some embodiments, conveyor 1234 is a rotatable screw auger that moves solid sorbent pellets made of sorbent 1400 dropped into the chamber and then moves solid sorbent pellets out an output port 1232 of the chamber.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A method for extracting carbon dioxide from air flow from a cooling tower, the method comprising:
blowing air over a contactor, the contactor comprising solid sorbent material to absorb carbon dioxide from the blown air, wherein the contactor is coupled to a cooling tower;
absorbing, by the solid sorbent material, carbon dioxide from the blown air;
transporting the solid sorbent material to a regeneration reactor;
extracting the absorbed carbon dioxide from the solid sorbent material in the regeneration reactor;
storing the extracted carbon dioxide into a pressurized container; and
after extracting the carbon dioxide, transporting the solid sorbent material from the regeneration reactor to the contactor.

2. The method of claim 1, wherein the sorbent material comprises at least one of magnesium oxide, aluminum oxide, potassium carbonate, activated carbon, monoethylamine, glycine, or sarcosine.

3. The method of claim 1, wherein the sorbent material comprises aluminum oxide, potassium carbonate, activated carbon, or a combination thereof.

4. The method of claim 1, wherein the sorbent material has a structure comprising at least one of powder, granules, pellets, monoliths, foam, laminate, fabric, structures, or a combination thereof.

5. The method of claim 1, wherein the extracting the absorbed carbon dioxide from the solid sorbent material comprises:
creating a vacuum environment by extracting air from a chamber containing the sorbent material; and
heating the sorbent material to a temperature sufficient to cause the sorbent material to release the absorbed carbon dioxide.

6. The method of claim 5, wherein the temperature is about 80° C. to about 600° C.

7. The method of claim 6, wherein heating the sorbent material lasts about 30 minutes to about 200 minutes.

8. The method of claim 1 wherein the contactor is directly coupled to an inlet of the cooling tower.

9. The method of claim 1, wherein the contactor is removably attached to the top of the cooling tower.

10. A carbon dioxide capture system comprising:
an air contactor, the air contactor containing a solid sorbent material to absorb carbon dioxide;
a regeneration reactor configured to extract the absorbed carbon dioxide from the solid sorbent material; and
a carbon dioxide capture and containment system.

11. The system of claim 10 further comprising:
a conveyor coupled to the air contactor and the regeneration reactor to transport solid sorbent and adsorbed carbon dioxide from the air contactor to the regeneration reactor; and
a conveyor coupled to the regeneration reactor and the air contactor, the conveyor configured to transport processed sorbent from the regeneration reactor back to the air contactor.

12. The system of claim 10, further comprising:
wherein the air contactor is directly coupled to a cooling tower.

13. The system of claim 10, further comprising:
wherein the air contactor is removably attached to a cooling tower.

14. The system of claim 10, further comprising:
a conduit coupled to an air outlet of the cooling tower and to an air inlet of the air contactor.

15. The system of claim 10, wherein the air contactor is configured to move from a first position outside of regeneration reactor to a second position within regeneration reactor, and wherein the system is configured to release adsorbed carbon dioxide when the air contactor is in the second position.

16. The system of claim 10, further comprising a cartridge comprising the solid sorbent material, wherein the air contactor is configure to receive the cartridge.
